(19) United States
(12) Patent Application Publication
(10) Pub. No.: US 2012/0243807 A1
(43) Pub. Date: Sep. 27, 2012

(54) Gas exhaust valve for packages

(76) Inventor: Gregory A. Pascoe, Chalfont, PA (US)

(21) Appl. No.: 13/065,645

(22) Filed: Mar. 25, 2011

(51) Int. Cl. B65D 33/01; F16K 15/14

(52) U.S. Cl. 383/103; 137/843

(57) ABSTRACT

An environmentally advantageous gas exhaust valve to control pressure changes in a container relative to the outside atmosphere, such as release of excessive pressure buildup in a bag as well as the introduction of a vacuum in a bag. A valve includes a valve cap, a diaphragm spring plate with flaps and can also includes a viscous material. A gas exhaust valve according to the invention is especially useful for coffee packages. The valve can also contain a cavity plate having multiple directional cavities and a viscous seal to allow the gas build up to escape, re-seal and thereby control pressure. A relief hole plate layer can also be provided, having a plurality of internal relief holes and a seal/filter layer and a filter seal to prevent the fine particles of the product inside the package from clogging the relief valve and interfering with its functionality and operation.

### INTRODUCTION

A multi-stage valve according to the invention is provided which has particular applicability for the retail gourmet coffee package market. However, a gas exhaust valve according to the invention can be also used with packages or containers holding other particulate food products or chemicals. The valve comprises a cap that holds the diaphragm layer having multiple flaps and that can control the egress of gas. The valve can provide both high and low pressure relief to prevent damage and unsightly deformation of a bag, and can provide for the introduction of a vacuum into a bag, such as during production. The degassing valve is not injection molded as one piece, but instead can be formed and laminated from multiple substrates or layers, each serving a particular valve function and can reduce the velocity of a gas, or its pressure, across a cross-section of the valve. The gas exhaust valve can be heat-sealed or welded to the inner surface of a container, or to a sealant layer of the container.

The inventive valve is an improvement over industry standard pop-off valves for reducing excessive internal buildup of pressure and preventing deformation of packages. A valve according to the invention can provide, for a degassing valve fabricated from biodegradable or otherwise environmental friendly material capable of being sealed or heat-welded to the inside a coffee package made of like material. Currently such is not possible with valves fabricated by injection molding, such as those adapted for retail coffee bags while maintaining current industry standard appearance.

In addition, biodegradable materials appropriate for use in such a device are not susceptible to an injection molding process for manufacture with existing machinery. A valve according to the invention can be fabricated using biodegradable materials and can be used with a bag made of biodegradable material and well as a variety of other materials, and can be applied to the package using existing machinery without significant retooling. In addition, a valve according to the invention can be thinner than existing valves, and reduce the amount of material currently used in industry standard valves. Furthermore a valve according to the invention can reduce a producer's costs and provide an alternative to expensive injection molded valves.

Increased reliability is another benefit of a valve according to the invention, as well as improved repeatability and resilience to extreme conditions that can cause standard valves to fail.

### FIELD OF THE INVENTION

This invention is related to the art of gas exhaust valves, and more particularly to a gas exhaust valve fabricated as a laminate structure from biodegradable material that can be heat-sealed or welded to the inner surface of a flexible packaging container of like material.

This invention provides for a relief valve which can be incorporated into or attached to the surface of a flexible package. More particularly, this invention relates to the method of manufacturing, construction and use of a degassing relief valve that is laminated from multiple substrates or layers, each serving a particular valve function. Alternatively, or in addition, the valve can be used to create vacuum inside a package and allow gas within the package to escape to the ambient atmosphere.

### BACKGROUND OF THE INVENTION

Pressure relief valves have been used to vent product packaging that store materials apt to produce gases over an extended period of time. Such pressure relief valves are used to vent these gases while simultaneously sealing the package from the outside environment. In doing so, the excessive pressure caused by the gaseous buildup is released, thereby preventing distortion and/or damage to the packaging. Previous valves have been generally made of polymeric material fabricated by injection molding. Moreover, such valves were often glued to the interior of the product packaging.

Various types of flexible and rigid packaging containers and valves for holding particulate materials, e.g., ground or whole bean coffee, other food products or chemicals are known and commercially available today. Some are also disclosed in the patent literature. Examples of packaging containers and valves used with those containers are found in the following U.S. patents.

U.S. Pat. No. 4,444,219, to Hollenstein discloses a pressure relief valve that is fluid-tightly joined to a package having flexible walls. The valve has a number of valve openings beginning at the valve seat with concentric channels around it in the seat to take up a sealant. The diaphragm is made of a single piece of material running on one side of the walls to the other without any holes therein. It is kept in position in a middle part of the valve seat so that the diaphragm may be moved freely, at least over the valve openings.

U.S. Pat. No. 5,584,409 to Chemberlen discloses a pressure relief valve having a first member which is substantially rigid, and which includes an outer sealing region and a raised section having at least one hole therethrough; and a second member which is substantially elastic, and which is in close proximity to, and preferably in contact with, the raised section of the first member and is sealingly secured to the first member at the outer sealing region.

U.S. Pat. No. 6,056,439 to Graham discloses a degassing valve mounted on the wall panel of a package and basically comprises a cap, a base and a flexible disk. The cap is a hollow cylindrical member from which three peripheral portions are cut away to form three equidistantly spaced peripheral outlet ports disposed above an uninterrupted ring-like portion of the cap. The base is a generally cup-shaped member having first portion arranged to be located and snap-fit within the cap member and which forms a valve seat. An inlet port extends to the valve. The disk is located on the valve seat and covering the inlet port but is moveable with respect thereto.

Typically, when packages are used to store any particulate or odorous products, like powder, coffee, detergents, organic liquids or chemicals, the valves used to vent gases out of the hermetically sealed packages containing such products are commonly known as one-way “degassing” or “relief” valves. These one-way valves are typically attached to or incorporated into the packaging in order to allow the gasses developed by the product inside the package, for example coffee, to vent out of the packaged container to the ambient atmosphere. This venting process is critically important in that it prevents the build-up of internal pressure inside the package, which can result in damage to the container or bulges in the container structure. At the same time, this type of valve can prevent the ingress of air into the package and damage to the package content.

While a variety of “degassing” or “relief” valves have been used with flexible packages for particulate food products, liquids and chemicals, there are several known problems with these valves. First, with greater emphasis on the use of bio-degradable materials in packaging, there is a need to reduce the size—and particularly the thickness—of the injection-molded plastic valves used with coffee and other packaging and the amount of excessive material used by each valve. Second, the known injection molded relief valves currently used with flexible packages present a problem and require additional expenses during the injection-molding process, and typically require the use of low-speed machines for assembly. In addition, there is an added expense and problems associates with the process of insertion of an injection molded valve in the punched hole in the package, including retooling of existing machinery. Third, because of the added thickness of the typical injection molded degassing valves, the empty packages with inserted or attached valves typically cannot be easily stacked up on top of each other during shipping or in storage. Fourth, the injection molding process requires complex methods. Therefore, there is a need for a more cost-effective process that can produce thinner and more reliable valves that would fill the requirements for repeatability (number of times that the valve can be used), resemble industry standard valves, maintain reliable performance of the valve in extreme conditions, fulfill biodegradability or sustainability standards, and can be applied to biodegradable packing using existing machinery without significant retooling.

There is also a need for an improved degassing valve for use in the retail gourmet coffee packaging and similar package that is biodegradable and utilizes substantially-less material while maintaining the standard industry appearance. More particularly, there is a need for a degassing valve that can be heat-sealed to the inner layer of the packing container yet is not injection molded but rather attached by a laminate substrate. A valve according to the present invention can fulfill these needs in a reliable and cost-effective product.

### OBJECTS OF THE INVENTION

It is therefore one objective of the present invention to provide a “degassing” or “relief” valve that addresses the problems and issues of the injection molded valves currently used in the industry, such as those that are discussed above.

It is another object of this invention to provide a degassing relief valve that seeks to reduce excessive gas buildup and to prevent deformation of the packaged product. Another object of the invention is to provide a degassing relief valve that is biodegradable and environmentally-friendly while maintaining the standard valve appearance prevalent in the industry. Another object of the invention is to provide a degassing relief valve that utilizes substantially-less material, decreases costs, and increases reliability under normal and extreme conditions.

It is another objective of the present invention to provide a valve that is formed and laminated from multiple substrates or layers, each serving a particular valve function. It is a further object to provide a valve that is at least as tamper resistant, and which can either relieve pressure within a package and/or introduce a vacuum into a package.

It is yet another an objective of the present invention to provide a degassing valve that is substantially thin and flat in shape. The process of utilizing thin substrates that serve various function of the valve allows creation of a thin and reliable degassing valve in accordance with the invention.

It is further objective of the present invention to provide a degassing valve fabricated of biodegradable or other sustainable material that can be applied to the inside surface of a package of like material and that does not deform or fail to operate under extreme conditions. Another object of the invention is to provide a valve which can be applied to a linerless or backless label that can itself be applied to the inside of a package.

It is yet a further objective of the present invention to provide a degassing valve that is sufficiently rigid, reliable and effective, and at the same time inexpensive to manufacture. A manufacturing process according to the invention can create a multi-layer valve that is less expensive than the injection molding process and can produce a valve of superior quality.

An object of the invention is to provide a valve which can be manufactured in conventional mass production machines without significant retooling of those machines to produce the valve or to incorporate the valve into a package.

Another object of the invention is to provide a value which can release small amounts of gas over an extended time under normal pressure circumstances, and to release large amounts of gas in a short period of time under high-pressure circumstances. It is a further object to provide a valve which can be incorporated into packages to release pressure during transportation at high altitudes, and which can maintain the appearance of the package over a long shelf-life without noticeable bulging.

Another object of the invention is to provide a value which can reseal effectively and repeatedly.

A further object is to provide a valve that is not molded and assembled, but laminated from multiple substrates having a valve cap that can function as a seal flange to be heat sealed or welded to the inner sealant on a package or a flat film web for a package. Another advantage of the invention is to provide a valve which can be fabricated using one step “in-line” hole punching during production thereby facilitating manufacture.

These and other objectives and advantages of the present invention will become evident from the description and drawings that follows.

### SUMMARY OF THE INVENTION

The present invention provides a degassing valve that is not injection molded, but instead is formed and laminated from multiple substrates or layers, each serving a particular valve cap function.

Accordingly, a biodegradable gas exhaust valve is provided for permitting the release of gases from an enclosed container. The valve includes a valve cap having at least one aperture; a diaphragm spring plate having at least one flap; and a relief hole plate disposed beneath the diaphragm spring plate. The relief hole plate is provided with a plurality of relief holes, each forming a passage from a lower surface of the relief hole plate to an upper surface of the relief hole plate. In addition, the valve cap is disposed above the diaphragm spring plate, and at least one aperture is disposed above the diaphragm spring plate to receive at least a portion of at least one of the flaps.

An embodiment of a biodegradable gas exhaust valve according to the invention can also include a cavity plate disposed beneath the diaphragm spring plate. The cavity plate is provided with a plurality of cavities, each forming a passage from a lower surface of the cavity plate to an upper surface of the cavity plate.

In another embodiment of a biodegradable gas exhaust valve according to the invention, a viscous material can be provided and disposed below the diaphragm spring plate.

In a further embodiment of a biodegradable gas exhaust valve according to the invention, a relief hole plate can be provided and disposed beneath the diaphragm spring plate. As before, the relief hole plate is provided with a plurality of relief holes, each forming a passage from a lower surface of the relief hole plate to an upper surface of the relief hole plate. A tortuous passage can be formed through the passage in the relief hole plate and the passage, through the diaphragm plate, and through the aperture in the diaphragm spring plate.

In another embodiment of a biodegradable gas exhaust valve according to the invention, a filter can be disposed beneath the diaphragm spring plate. In another embodiment, at least one filter seal can be provided.

Different embodiments of a biodegradable gas exhaust valve according to the invention, can be provided with different viscous materials, such silicone fluid, a silicon fluid impregnated material, or a polymerized elastomer. In addition, the viscous material can be provided in different areas of the valve, such as at a portion of an aperture of the spring plate. Alternatively, the viscous material can be provided in at least one cavity of the cavity plate. As another example, the viscous material is disposed between said relief hole plate and said cavity plate. In a other embodiments, the viscous material can be embedded in the spring plate, cavity plate, and/or relief hole plate.

In another embodiment of a biodegradable gas exhaust valve according to the invention, different types of flaps can be provided, such as a high pressure flap and/or a low pressure flap. For example, the high pressure flap can be provided with a larger aperture and can cooperate—or be associated—with one kind of viscous material, and the low pressure flap can be provided with a smaller aperture and can cooperates—or be associated—with a second type viscous material. In one embodiment, the first kind of viscous material can have a greater viscosity than the second kind of viscous material. Alternatively, the first kind of viscous material can have a lesser viscosity than the second kind of viscous material.

In another embodiment of a biodegradable gas exhaust valve according to the invention, a reservoir plate can be provided having a first reservoir space and a second reservoir space. A first kind of viscous material can be disposed in the first reservoir space and a second kind of viscous material can be disposed in a second reservoir space. For example, the first kind of viscous material can have a greater or lesser viscosity than the second kind of viscous material.

In another embodiment of a biodegradable gas exhaust valve according to the invention, the valve cap can be provided with a flap limiter, such as a protrusion which extends into the space in which the flap is intended to move.

In the various embodiments mentioned, many of the parts can be fabricated from biodegradable materials. For example, the filter seal can be fabricated from a biodegradable material. In addition, the filter seal can be fabricated from roll stock that is thicker than the other parts of the vale in order to add to the thickness of the valve which can be useful for adapting the valve to be compatible with existing machinery, such as for fabricating the valve, or incorporating the valve into a structure, such as a bag.

In various embodiments, the relief hole can be provided to be offset from the cavity. In addition, the viscous material can be provided between the relief hole plate and the cavity plate to form a tortuous path. Alternatively, the relief hole can be offset from the aperture of the spring plate, and the viscous material can be provided between the relief hole plate and the spring plate to form a tortuous path. In a further embodiment, at least one of the cavities can be offset from at least one of the apertures of the spring plate, and the viscous material can be provided between the cavity plate and the spring plate to form a tortuous path. In a further embodiment, at one of the cavities is offset from at least one of the apertures of the spring plate, and a viscous material is provided between the cavity plate and the spring plate to form a tortuous path.

In other embodiments of the invention, a valve flange can be included and disposed around an outer edge of the valve cap, diaphragm spring plate and a relief hole plate. The valve flange is provided with an aperture at its bottom end which holds the relief hole plate within the flange and which permit gas to pass through a path in the valve cap, the diaphragm spring plate and the relief hole plate.

Another aspect of the invention is providing the valve with a bag, each adapted for use with the other. The bag is preferably fabricated substantially from a biodegradable material to form a container having at least one wall. The biodegradable gas exhaust valve is attached to a side of said wall. The valve includes an embodiment as described above, specifically having at least a valve cap having at least one aperture, a viscous material and a diaphragm spring plate having at least one flap. In addition, the valve cap is disposed above the diaphragm spring plate, and the at least one aperture is disposed above the diaphragm spring plate to receive at least a portion of the at least one flap.

### BRIEF DESCRIPTION OF THE DRAWINGS

Preferred embodiments of the inventive devices are illustrated in the drawings and are described below, though not necessarily to scale.

FIG. 1 illustrates an exploded view of structures which can be included in an embodiment of a valve according to the invention.

FIG. 2 illustrates an exploded view of structures included in an embodiment of a value according to the invention.

FIG. 3 illustrates an exploded view of structures included in an embodiment of a value according to the invention.

FIG. 4 illustrates an structures which can be included in an embodiment of a valve according to the invention.

FIG. 5 illustrates an exploded view of structures included in an embodiment of a value according to the invention.

FIG. 6 illustrates a cross-section view of an embodiment of a gas exhaust valve according to the invention.

FIG. 7 illustrates a cross-section view of an embodiment of a gas exhaust valve according to the invention.

FIG. 8 illustrates an exploded view of structures included in an embodiment of a value according to the invention.

FIG. 9 illustrates an exploded view of structures included in an embodiment of a value according to the invention.

FIG. 10 illustrates an exploded view of structures included in an embodiment of a value according to the invention.

Throughout the figures, the same reference numerals and characters, unless otherwise stated, are used to denote like features, elements, components or portions of the illustrated embodiments. The drawings are provided for illustration purposes only and are not to scale. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION AND PREFERRED EMBODIMENT

A detailed description of a gas exhaust valve for packages is provided below for general applicability. In addition, several specific embodiments are provided as examples of the devices which one of ordinary skill in the art may apply these teachings to address specific problems and to illustrate the benefits and improvements of the system over known solutions.

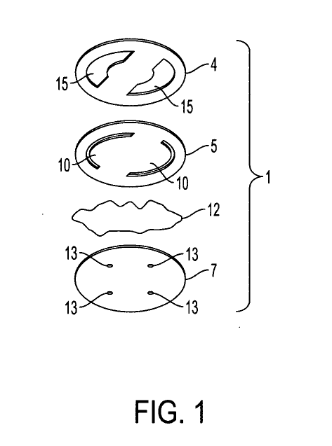

FIG. 1 shown an embodiment of a valve 1 according to the invention, which includes a valve cap 4, and a diaphragm spring plate 5. In one embodiment, a valve cap 4 can be provided to hold the diaphragm spring plate 5 of the valve and to control the egress of gas from the inside of the packaging container 2, and/or protect the diaphragm spring plate 5 such as from impacts.

A diaphragm spring plate 5 is provided on an inner side of the valve cap 4. A diaphragm spring plate 5 can be provided as a layer of flexible material, such as an elastomer, which can be underneath the cap 4. A polymer or cellophane can be acceptable materials. The valve cap 4 includes one or more apertures 15 to permit all or a part of a flap 10 of the diaphragm spring plate 5 to extend into the valve cap 4 upon the application of gaseous pressure. This allows the passage of gas build-up from the inside of the package 2 to the outside through the valve and through one or more holes in the package wall provided at a portion of the wall where the valve is connected. The outer edge of the valve cap 5, or edge of an outer layer of an embodiment of a valve, can be used for making a connection to a surface of a package. Accordingly, it can be appreciate that the valve cap 5, or edge of an outer layer of an embodiment of a valve can be provided with a outer ring or surface of sufficient area to form a connection with the surface of a package.

A diaphragm spring plate 5 can be provided with one or more flaps 10 to permit exit of gas build-up in the container. Multiple flaps 10 can be provided to control the flow of gas under different conditions, such as to provide for the release of gas under low and high pressure conditions. A diaphragm spring plate 5 according to the invention can be fabricated from sheet or roll stock of approximately 3 mils, such as elastomer or polyester, or linear low-density polyethylene.

A valve according to the invention can also include a viscous material 12 for providing a seal and which can allow the egress of the gas through the valve, such as from bottom to top of a valve, or from the inside to the outside of a package 2. For example, when a sufficient pressure is built up on one side of the valve, the pressure forces the flexible diaphragm plate 5 to move and release a seal formed by the flap 10 with other components of the valve. After pressure is released, the flap can return to its closed position thereby resealing the valve. Addition of a viscous material 12 can provide for a better seal and improved repeated performance of a valve according to the invention.

The viscous material 12 is provided to create a substantially air-tight seal in coordination with other components of the valve and which can break and re-seal under certain conditions. In one embodiment of a valve according to the invention, the viscous material can be provided in the form of an oil, a silicone fluid, a viscous elastomer, or other substance having sufficient viscosity to provide for breaking of the seal at specified pressures and resealing of the seal after pressure is relieved. Specific examples include dimethylpolysiloxanes and GESF1000. Alternatively, the viscous material can comprise or includes a pressure sensitive adhesive (PSA) or other viscoelastic materials which can provide for a temporary bond upon application of pressure or shear stresses.

In addition, or in the alternative, the viscous material can be provided inherently within the structure of other material components of a valve according to the invention or coating one or more of the structural components of the valve, such as the cavity plate 6, and/or the relief hole plate, and/or the diaphragm spring plate. In addition, or in the alternative, the viscous material 12 can be provided in the spaces, apertures, and/or cavities provided in within the valve to form a path by which gases can pass from a bottom portion of the valve to the top portion, and vice-versa, such as the relief holes 13, and/or cavities 11, the flap slits, and/or aperture 15 of a valve cap. In addition, or in the alternative, a space can be provided between one or more layers of the valve, such as between the spring plate 5 and the cavity plate 6 and/or relief hole plate 7 to provide for a layer of viscous material 12. The size, contact area of the path, and viscosity of the viscous material affect the sealing characteristics of the viscous material in coordination with other parts of the valve.

A valve according to the invention can be connected to a wall of a container 2. The valve can be heat sealed and attached as a part of a container 2, such as a filter bag that holds the food product, chemicals or other products inside. Preferably, the valve is used with a container made of biodegradable flexible material or film, and affixed to an inner surface of a container or between two or more surfaces of a container wall. For example, the valve cap 4 can be fabricated from the same material as the container to facilitate connection of the valve to the container, such as a biodegradable material which can be heat-sealed to another biodegradable material. In one embodiment of a valve according to the invention, which can be adapted for use with coffee bags, one or more components of the valve can be fabricated from materials ranging in thickness and a produced having a range in diameters. For example, valve components can range from 1 mil to 20 mils in thickness, and range from 19 to 25 mm in diameter to meet industry standard and/or for fabrication using existing machinery.

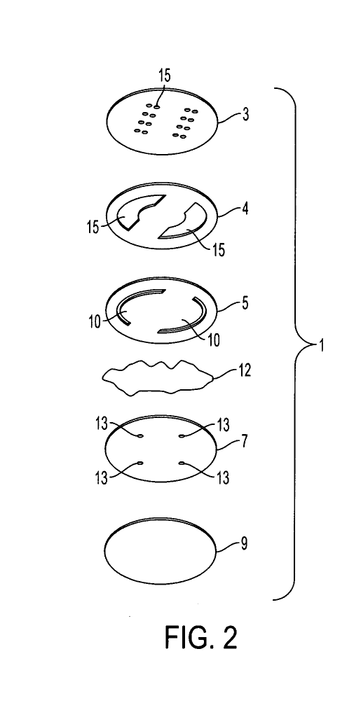

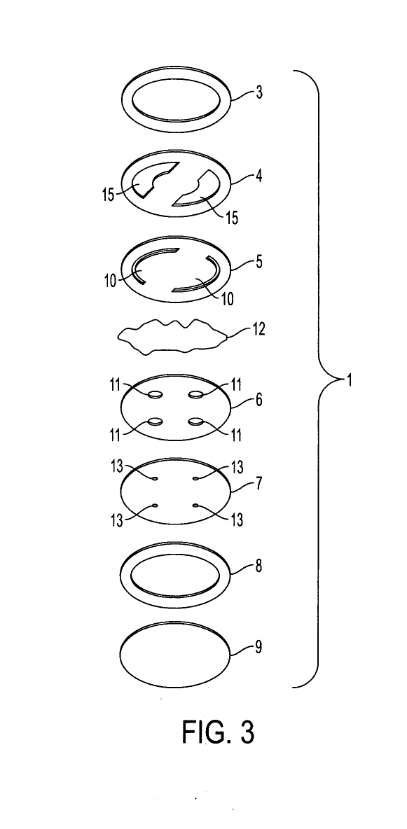

FIG. 2 shown another embodiment of a valve according to the invention, in which a filter seal 3 and/or a relief hole plate 7 can be provided. In addition or in the alternative, one or more filters 9 can be provided. The valve cap 4 may rest below a top build-up ring or filter seal 3, such as shown in FIGS. 2 and 3.

The filter seal 3 can be provided for a number of functions, including making sealed connection to a container, and/or adding material to provide bulk to the thickness of the valve, among other things. For example, in one embodiment the filter 3 can be fabricated from a thin-gauge substrate, such as 1-2 mil polyethylene, or a polymer of like material to the container 2. In one embodiment, the filter seal 3 can be provided as having a plurality of aperture, or it can be provided with a single aperture, such as being provided approximately as a ring to form a connection for sealing the valve to the container. Alternatively, or in addition, the filter seal 3 can be thicker, such as 10-20 mils to allow for additional build up of the material, which may be desireable to adapt the ring for use with an in-line production process for attaching to a bag without retooling.

Accordingly, in an embodiment of a valve 1 according to the invention having a filter seal 3, the valve cap 4 can be fabricated from relatively thin material, such as roll stock or sheet stock having 1-2 mils thickness. In an alternative embodiment of a valve according to the invention, the filter seal 3 can be omitted and the valve cap 4 can be provided on an outside portion of the valve and be adapted to provide at least one of the functions of the filter seal 3, such as providing a sealed connection to a container. In such an embodiment, the valve cap 4, can be fabricated from a polymer of like material of the container, and be provided with greater thickness such as 10-20 mils. In such an embodiment, the valve cap 4 can be used to make connection with the container 2 and the cap 4 is preferably heat-seal welded or attached by other known means to the inside surface of the container 1.

The relief hole plate 7 can be provided having a plurality of internal relief holes 13 through which gas can escape and release pressure, and prevent particles in the container from clogging the valve. The internal relief holes can vary in size to accommodate the size of the material in the container to be excluded. Accordingly, the internal relief hole plate 7 can be disposed in the valve between the spring plate 5 and the material of a container, although other component may be included proximate the internal relief hole plate 7 in different embodiments. Through the internal relief holes 13, internal pressure can be applied via gas flow onto the flexible diaphragm layer 5 and viscous seal 12 of the cavity plate 6, which can cause the opening of the diaphragm and escape of the built-up gaseous pressure from the inside of the package.

FIG. 3 shows an alternative embodiment of a valve according to the invention wherein a cavity plate 6 is provided having at least one cavity 11 having an area larger than an associated relief hole. The cavity 11 can allow the gas to escape through the cavity 11 in the plate 6 and apply pressure from the relief holes over a larger area of an associated flap. For example, gas passing through a relief hole 13 can then pass through an associated cavity proximate to the relief hole and then against an associated flap 10 proximate to the cavity 11, and then out an aperture 15 of the valve cap 4. In one embodiment, the cavity plate 6 can be provided below the flexible diaphragm 5 and be fabricated from roll or sheet stock having a thickness of approximately 10 mils. The cavity plate 6 can permit more uniform pressure distribution and application of force due to gas build up onto the flexible diaphragm 5. This results in a more reliable operation and less wear of the flexible diaphragm 5. In addition, one or more of the cavities 11 of the cavity plate can used provide a reservoir store for all or part of the viscous material 12.

It can be appreciated that in an embodiment of a valve according to the invention can be provided where one or more cavities 11 are disposed in the cavity plate 6 at different locations relative to a flap 10 depending upon the design of the valve, such as centered beneath or at the edge of a flap of the spring plate 7. In addition, one or more of the cavities can be disposed above relief holes 13 of a relief hole plate 7, or offset from the relief holes 13.

The cavity plate layer 6 and/or diaphragm spring plate 5 can be provided to include the viscous material 12. For example, the cavity plate 6 or spring plate 5 can be coated with or impregnated with the viscous material 12, and a separate layer of viscous material 12 or addition or viscous material 12 to one of the cavities either omitted or included. For example, in an alternative embodiment of a valve according to the invention, a layer of viscous material 12 can be provided in a space of the valve, such as between the cavity plate 6 and the diaphragm spring plate 5. The viscous material 12 can be oil or an oil impregnated material such as a polymerized elastomer formed into one of the components, such as the cavity plate 6 or spring plate 5.

The relief holes 13 and/or cavities 11 direct the velocity of gases passing through the valve and can control the bursting characteristics of the valve for sudden changes in pressure. In an alternative embodiment, a relief hole plate 7 can be provided directly below the diaphragm spring plate 5, and the cavity plate 6 can be separated by one or more additional layers. In an alternative embodiment, the flexible diaphragm 5 can rest directly on the relief hole plate 7, and the cavity plate 6 omitted. The relief hole plate 7 can be fabricated from matter B or PLA polymer and can be approximately 2-3 mils in thickness.

A filter seal 8 can be provided below the hole plate 7. In one embodiment, the filter seal can include a filter 9, or be disposed to hold a filter 9 in place. A filter 9 can comprise a thin porous material, such as coffee filter paper or Wa filter paper, and can be provided to prevent leakage of viscous material 12. In addition, the filter seal 8 can be provided to prevent dust particles and/or other contaminants from entering the package and filter out dust particles and other fine particles from escaping through the internal relief holes and the diaphragm layer 5 to the outside. In addition, the filter seal 8 can prevent the particles of the product inside the package from clogging the relief valve holes, thereby interfering with the degassing function of the valve (allowing build-up gases to escape) and causing a build-up of pressure against the container walls and potential deformation of the package. In some cases, such as in packages holding very fine particulate materials, the holes or passages can become partially or totally occluded or clogged with the particles, causing the valve to malfunction and stop providing the egress of the gas, or causing the flaps flexible diaphragm to remain in the open position, such that one or more flaps are lifted off the relief hole plate or optional cavity plate, and thereby allowing the ingress of the ambient atmosphere into the package container through the now open valve and accordingly, it can be appreciated that a finer filter may be used depending on the size of the particles. In addition, or in the alternative, the filter seal 8 can provide additional thickness or mass to a valve according to the invention and can be fabricated from materials such as polyethylene or vegetable polymer, and can be approximately 10-20 mils in thickness.

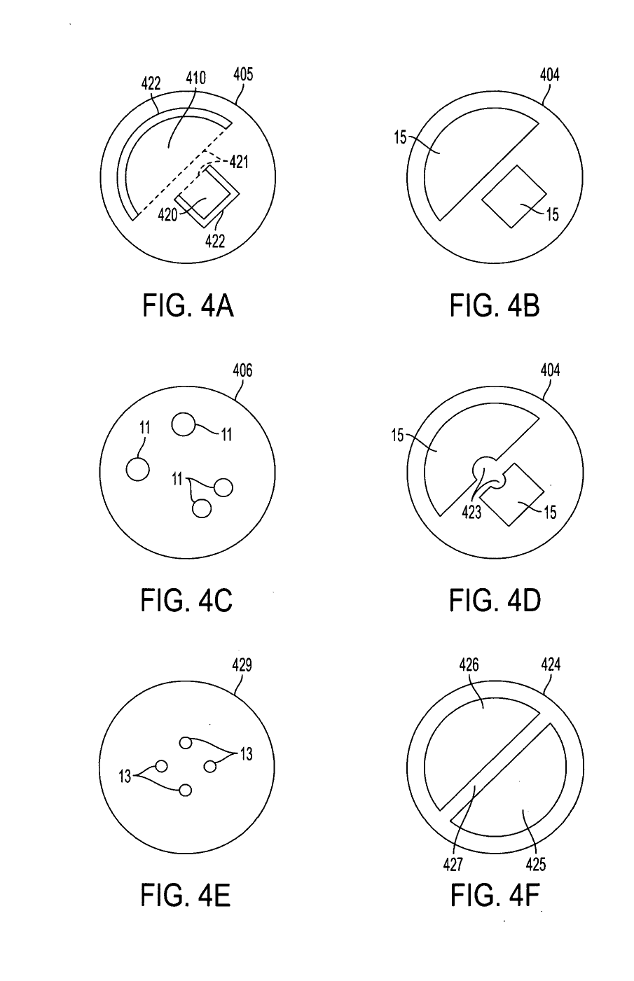

Alternative embodiments of components of one or more valves according to the invention are shown in FIGS. 4A-F.

A flexible diaphragm spring plate 405 is shown in FIG. 4A which can include at least two flaps 10 providing different functions. For example, a first flap can be a high pressure flap 410 and a second flap can be provided as a low pressure flap 420. The performance of each flap can be modified according to the expected environmental conditions, container material and desired action of the valve. The characteristics of a flaps performance can be modified according to the choice of the type and thickness of the material of the spring plate 405, the width of the hinge portion 421 of a flap 410, the size of the slit 422 of a flap, the type and amount of viscous material 12 used, the size and positioning of cavities 411 associated with a flap. For example, it can be appreciated that the width of the hinge can be made wider or narrower and size of the flap smaller or larger to adjust the lever arm movement of a flap, and thereby provide for improved performance of the valve at altitude. Furthermore, it can be appreciated that he flaps can be provided in varying shapes and/or offset from the center of the valve. It can be appreciated that the flaps can be die cut and positioned at or near the apertures in other components of the valve

FIGS. 4B and 4D show embodiments of a valve cap 404 having apertures 15 to conform with the approximate size and dimension of an associated flap in order to accommodate an opening flap, while protecting the spring plate 5 from impacts. In an alternative embodiment of a valve according to the invention, a valve cap 404 can be provided with one or more flap limiters 423 to limit the motion of associated flaps. The flap limiter 423 can be provided as a protrusion of the valve cap 404 material over portions of the flap, such as the hinge 421 area of a flap.

Thus, thus different embodiments of a valve according to the invention can be provided with different flaps to satisfy different purposes. In one embodiment, for example, at least one flap 10 can be provided to enable to slow release of a small amount of pressure over a period of time. In an embodiment of a valve for use with coffee bags, for example, such a valve can permit the slow escape of gas which may build-up inside a bag over time and thereby avoid damage to the bag, or an undesirable appearance of the bag. Accordingly, a flap 10 can be provided having a relatively small associated aperture 15 and/or slit to permit relatively low-pressure to release, such as at 2-5 millibars, upon overcoming of the tension of the seal formed by the valve, while preventing a large flow of gas or entry of particles in other circumstances.

Providing a high pressure flap 410 can be useful to enable a valve according to the invention to release a high volume of gas and prevent damage to a bag such as when abrupt pressure changes are incident to the bag when a bag is rapidly compressed. For example, a high pressure flap 410 can be provided whereby greater force may be required to activate the flap, such as 15 millibars, whereupon a large volume of gas may be permitted to evacuate. A high pressure flap 410 can be provided with a relatively wide hinge 421 and/or a relatively thin slit 422 such that greater force may be required to activate the flap and permit gas to escape. In addition, or in the alternative, a viscous material 412 can be chosen having greater viscosity. In addition, or in the alternative, a flap limiter 423 can be provided in cooperation with an aperture 415 of a valve cap which can resist the lever arm of a flap at its hinge.

FIG. 4C shows an embodiment of a cavity plate 406 having variations in the size and placement of the cavities 11. For example, larger cavities can be provided under a high pressure flap 410 and smaller cavities can be provided under a low pressure flap 420. In addition, the size and position of cavities can be chosen to vary the function of the valve. For example, a large cavity can be provided centered under a flap, and/or multiple small cavities can be provided under the flap.

FIG. 4E shows an embodiment of a relief hole plate 429 wherein the relief holes are provided in a first area of the plate 429, such as near its center, and offset from the position of the cavities 11 in a cavity plate 406, such as shown in FIG. 4c, which can be provided away from the center of the cavity plate 406.

Thus, in an alternative embodiment of a valve according to the invention, the holes 428 of the relief hole plate 429 can be provided offset from the associated cavities 411 of the cavity plate 406 to provide for a convoluted path for gas to flow through the valve. Alternatively, the relief holes 428, cavities 411 as well as flaps can be offset relative to one another in order to promote a convoluted, complex and/or tortuous path for gas passing through the valve 1. In addition or in the alternative, an embodiment of a valve can also include a column of viscous material 12 disposed in at least a portion of the path. The cavities 411 can be used to provide a pool or reservoir for containing all or a portion of the viscous material. Thus, a convoluted path can be provided and improve performance of a valve which can reseal after gas has been released.

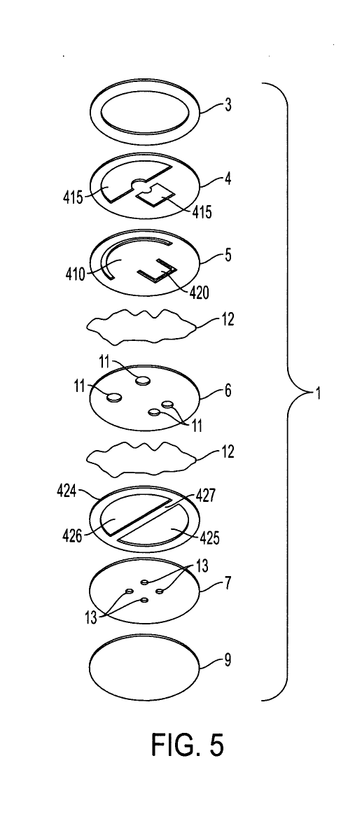

FIG. 4F shows an embodiment of a reservoir plate 424 for use with a valve according to the invention, such as an embodiment of a valve shown in FIG. 5. A reservoir plate provides a space for viscous material 412 to be provided and can form a portion of the convoluted path in the valve. The reservoir plate can be divided into two or more portions to provide separate reservoirs of viscous material 412. For example, a low pressure reservoir 425 and a high pressure reservoir 426 can be provided. The low pressure reservoir 425 can contain a viscous material associated with the low pressure flap 420 and form a low pressure valve path. In addition, a low pressure viscous material associated with the low pressure reservoir 425 can be provided in the low pressure reservoir, such as a viscous material having lower viscosity. Similarly, a high pressure reservoir 426 can contain a viscous material associated with the high pressure flap 410 and form a high pressure valve path. In addition, a high pressure viscous material associated with the low pressure reservoir 425 can be provided in the low pressure reservoir, such as a viscous material having higher viscosity. A reservoir partition 427 can be provided to separate a first reservoir space 425 and a second reservoir space 426.

FIG. 5 shown an embodiment of a valve according to the invention wherein components of the valve are provided to form at least two separate valve paths. For example, a diaphragm spring plate 5 can be provided having two different flaps, such as a high pressure flap and a low pressure flap. In addition, a reservoir plate 424 can be provided with a low pressure reservoir 425 and a high pressure reservoir 426. The reservoir plate 424 can be provided between a relief hole plate 7 and a cavity plate 6, if provided. Alternatively, the reservoir plate 424 can be provided between a relief hole plate 7 and the spring plate 5 or between the spring plate 5 and cavity plate 6, if provided. In addition, or in the alternative, one or more layers of viscous material 12 can be provided between the spring plate 5, cavity plate 6, and/or relief hole plate 7.

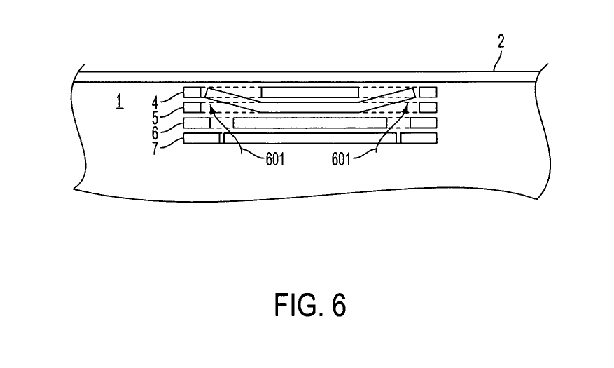

FIG. 6 shows a cross section view of an embodiment of a valve according to the invention wherein components of the valve are provided to form at least two separate valve paths 601.

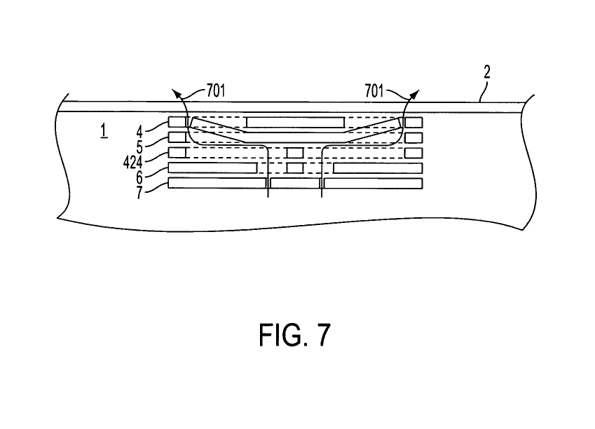

FIG. 7 shows a cross section view of an embodiment of a valve according to the invention wherein components of the valve are provided to form at least two separate valve paths 601. A convoluted path can be provided wherein at least a portion of a cavity 11 is offset in position from that of an associated flap 10. In addition, or in the alternative, a reservoir plate can be included to provide a space for gas to flow in a convoluted path from a cavity to an associated flap.

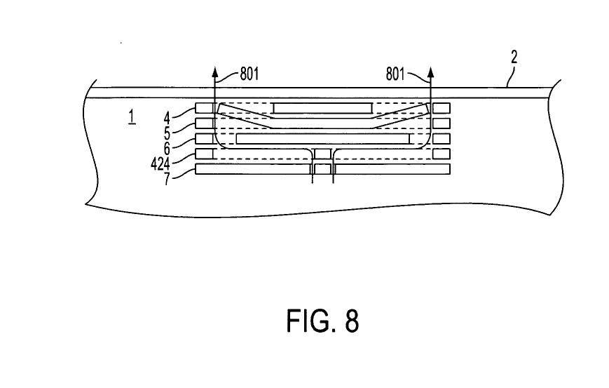

FIG. 8 shows a cross section view of an embodiment of a valve according to the invention wherein components of the valve are provided to form at least two separate valve paths, such as a high pressure valve path 801 and a low pressure valve path 802. A convoluted path can be provided wherein at least a portion of a cavity 11 is offset in position from that of an associated relief hole 13. In addition, or in the alternative, a reservoir plate can be included to provide a space for gas to flow in a convoluted path from a relief hole 13 to an associated cavity 11. Viscous material 12 can be provided in an embodiment of a valve according to the invention, such as shown in FIGS. 7 and 8, and disposed in at least a portion of the convoluted path, such as in a cavity 11 and an associated portion of a reservoir, to form a column through which gas must pass, and which can reseal after gas pressure has been relieved.

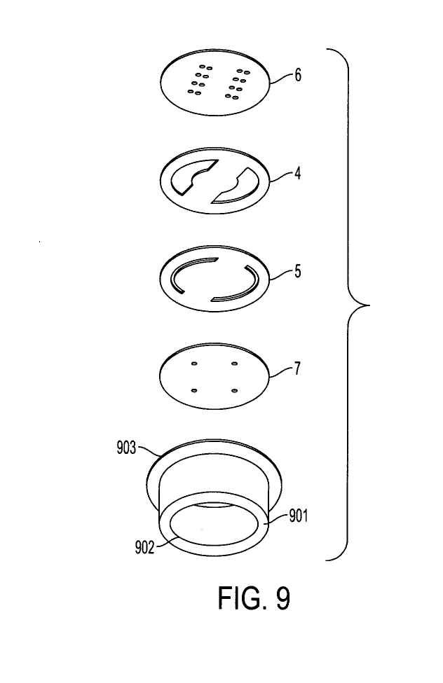

FIG. 9 shown an embodiment of a valve according to the invention wherein the above-described components of valve are adapted for use to fit substantially within and cooperate with a valve flange 901. A valve flange 901 can be provided to incorporate different embodiments of a valve according to the invention into a valve assembly for in-line production of a container connected to a valve. Accordingly, the valve flange 901 includes an outer wall for containing one or more of the components of a valve according to the invention, and a bottom portion 902 having an aperture smaller than the dimensions of the lowest component of the valve, such as the relief hole plate 7, where by the valve flange can contain the components of the valve at its lower extent while permitting passage of gas through the valve path. In addition, the valve flange can be provided with an upper connection portion 903 whereby the valve flange can make connection to a surface of a container 2.

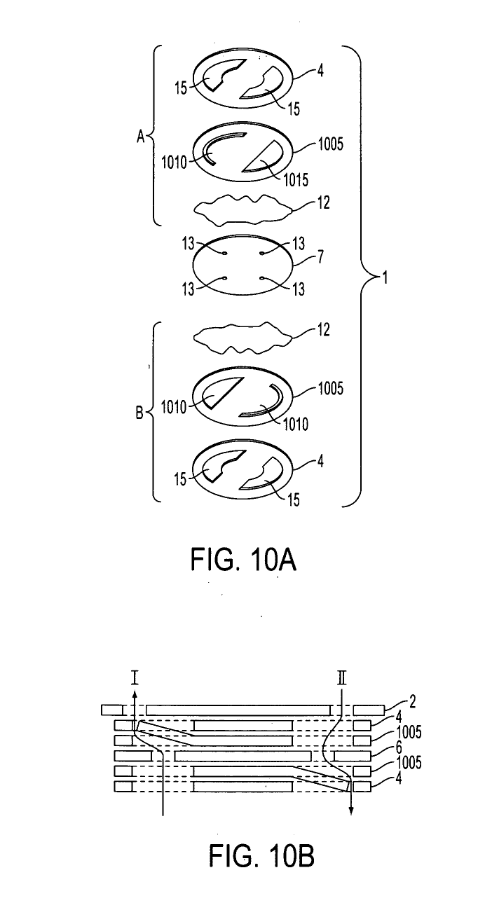

FIG. 10A shown an embodiment of a valve according to the invention wherein the valve provides dual pathways for pressure release on either side of the valve. FIG. 10B shows a cross-section of an embodiment. The valve includes a first set of valve structures A on a first side of a valve 1, and a second set of valve structures B on a second side of the valve 1.

The first set of valve structures includes a valve cap 4, a spring plate 1005 and a viscous material 12. One area of the spring plate 1005 is provided with a flap 1010 associated with a first pathway I. Another area of the spring plate 1005 is provided with an aperture 1015 associated with a second pathway II.

The second set of valve structures B include a valve cap 4, spring plate 1005 and viscous material 12. One area of the spring plate 5 is provided with a flap 1010 associated with the second pathway II. Another area of the spring plate 1005 is provided with an aperture 1015 associated with the first pathway I.

In addition, a relief hole plate and one or more other structures can be provided, such one or more filter seals 3, 8, filters 9 or valve flanges 901 which can be provided on either side of the valve, such as either above the first set of valve structures A or below the second set of valve structures B. In addition, a reservoir plate 424 can be provided between the spring plate 1005 and the relief hole plate 7 for either or both sets of valve structures A, B.

Components of a valve according to the invention can be fabricated by in-line punching, punch pressing, or die-cutting of roll stock or sheet stock. The components can then laminated together using either heat sealing, glue, or a combination or both. A valve according to the invention can be heat-sealed to a package, such as a bag, having the same or similar material as the material of the top portion of the valve. For example, the valve cap 4 of a valve according to the invention can be fabricated from biodegradable material, and be connected to a package fabricated for similar biodegradable material. In addition, a valve according to the invention can be adapted for use with a bag made of a variety of other materials, and this is applicable to a variety of uses.

Biodegradable or compostable components of a valve according to the invention can be fabricated from biodegradable or compostable materials such as vegetable polymers that satisfy industry standards depending on it intended use (e.g., ASPM 6400) such as EN13432.

1. A biodegradable gas exhaust valve for permitting the release of gases from an enclosed container, comprising:
a valve cap having at least one aperture;
a diaphragm spring plate having at least one flap; and
a relief hole plate disposed beneath the diaphragm spring plate, said relief hole plate having a plurality of relief holes, each forming a passage from a lower surface of said relief hole plate to an upper surface of said relief hole plate;
wherein said valve cap is disposed above said diaphragm spring plate, and wherein said at least one aperture is disposed above said diaphragm spring plate to receive at least a portion of said at least one flap.

2. A biodegradable gas exhaust valve according to claim 1, further comprising a cavity plate disposed beneath the diaphragm spring plate, said cavity plate having a plurality of cavities, each forming a passage from a lower surface of said cavity plate to an upper surface of said cavity plate.

3. A biodegradable gas exhaust valve according to claim 1, further comprising a viscous material disposed below the diaphragm spring plate.

4. A biodegradable gas exhaust valve according to claim 2, further comprising a relief hole plate disposed beneath the diaphragm spring plate, said relief hole plate having a plurality of relief holes, each forming a passage from a lower surface of said relief hole plate to an upper surface of said relief hole plate, and wherein a tortuous passage can be formed through said passage in said relief hole plate, said passage through said diaphragm plate, and through said aperture in said diaphragm spring plate.

5. A biodegradable gas exhaust valve according to claim 1, further comprising a filter disposed beneath the diaphragm spring plate.

6. A biodegradable gas exhaust valve according to claim 1, further comprising at least one filter seal.

7. A biodegradable gas exhaust valve according to claim 3, wherein said viscous material is selected from the group comprising a silicone fluid, a silicon fluid impregnated material, pressure sensitive adhesive and a polymerized elastomer.

8. A biodegradable gas exhaust valve according to claim 3, wherein said viscous material is disposed in at least a portion of an aperture of said spring plate.

9. A biodegradable gas exhaust valve according to claim 3, wherein said viscous material is disposed in at least one cavity of said cavity plate.

10. A biodegradable gas exhaust valve according to claim 4, wherein said viscous material is disposed between said relief hole plate and said cavity plate.

11. A biodegradable gas exhaust valve according to claim 1, wherein said viscous material is embedded in said spring plate.

12. A biodegradable gas exhaust valve according to claim 2, wherein said viscous material is embedded in said cavity plate.

13. A biodegradable gas exhaust valve according to claim 4, wherein said viscous material is embedded in said relief hole plate.

14. A biodegradable gas exhaust valve according to claim 1, wherein said at least one flap, comprise at least one a high pressure flap and at least one a low pressure flap.

15. A biodegradable gas exhaust valve according to claim 14, wherein said at least one high pressure flap is provided with a larger aperture and cooperates with a first viscous material, wherein said at least one low pressure flap is provided with a smaller aperture and cooperates with a second viscous material, wherein said first viscous material has a greater viscosity than said second viscous material.

16. A biodegradable gas exhaust valve according to claim 1, further comprising a reservoir plate having a first reservoir space and a second reservoir space.

17. A biodegradable gas exhaust valve according to claim 16, further comprising a first viscous material disposed in a first reservoir space and a second viscous material disposed in a second reservoir space.

18. A biodegradable gas exhaust valve according to claim 1, wherein said valve cap further comprises a flap limiter.

19. A biodegradable gas exhaust valve according to claim 1, wherein said filter seal comprises a biodegradable material.

20. A biodegradable gas exhaust valve according to claim 1, wherein said filter seal is fabricated from thicker roll stock to add thickness to the valve for use with existing machinery.

21. A biodegradable gas exhaust valve according to claim 4, wherein said relief hole is offset from said cavity plate, and wherein a viscous material is provided between said relief hole plate and said cavity plate to form a tortuous path.

22. A biodegradable gas exhaust valve according to claim 4, wherein said relief hole is offset from said aperture of said spring plate, and wherein a viscous material is provided between said relief hole plate and said spring plate to form a tortuous path.

23. A biodegradable gas exhaust valve according to claim 4, wherein at one of said cavities is offset from said at least one of said apertures of said spring plate, and wherein a viscous material is provided between said cavity plate and said spring plate to form a tortuous path.

24. A biodegradable gas exhaust valve according to claim 4, wherein at least one of said cavities is offset from said at least one of said apertures of said spring plate, and wherein a viscous material is provided between said cavity plate and said spring plate to form a tortuous path.

25. A biodegradable gas exhaust valve according to claim 1, further comprising a valve flange disposed around an outer edge of the valve cap, diaphragm spring plate and a relief hole plate, wherein the valve flange has an aperture-at its bottom end which holds said relief hole plate within the flange and which permit gas to pass through a path in said valve cap, diaphragm spring plate and a relief hole plate.

26. A bag comprising a biodegradable container having at least one wall, and a biodegradable gas exhaust valve attached to a side of said wall, said valve comprising a valve cap having at least one aperture, a viscous material and a diaphragm spring plate having at least one flap; wherein said valve cap is disposed above said diaphragm spring plate, and wherein said at least one aperture is disposed above said diaphragm spring plate to receive at least a portion of said at least one flap.
